(19) United States
(12) Patent Application Publication
(10) Pub. No.: US 2025/0003628 A1
(43) Pub. Date: Jan. 2, 2025

(54) AIRFLOW CONTROL SYSTEM, CONTROL METHOD, AND PROGRAM

(71) Applicant: Panasonic Intellectual Property Management Co., Ltd., Osaka (JP)

(72) Inventors: Hayato TAKAHASHI, Hyogo (JP); Nobuaki YABUNOUCHI, Kyoto (JP)

(21) Appl. No.: 18/708,933

(22) PCT Filed: Oct. 21, 2022
(86) PCT No.: PCT/JP2022/039232

§ 371 Date: May 9, 2024

(30) Foreign Application Priority Data
Nov. 26, 2021 (JP) 2021-192484

(51) Int. Cl. F24F 13/078; F24F 8/24

(52) U.S. Cl. CPC F24F 13/078; F24F 8/24

(57) ABSTRACT

An airflow control system includes an air blower, a supplier, a lighting fixture, and a controller. The air blower has an outlet port, from which an airflow with directivity is allowed to blow out. The supplier may supply the airflow blowing out from the outlet port with a functional component to be eventually emitted into the air. The lighting fixture may emit light having directivity in a direction aligned with a direction in which the airflow blows out from the outlet port of the air blower. The controller controls the air blower and the lighting fixture.

### TECHNICAL FIELD

The present disclosure generally relates to an airflow control system, a control method, and a program. More particularly, the present disclosure relates to an airflow control system including an air blower, a control method, and a program.

### BACKGROUND ART

Patent Literature 1 discloses a fluid carrier configured to let a fluid to carry, such as a gas or a liquid, blow out from an outlet port into a space to carry the fluid locally to a target spot, which is located at a distance from the outlet port, while reducing the diffusion of the fluid.

The fluid carrier of Patent Literature 1 does not allow a person to visually recognize the reachable range of an airflow.

### CITATION LIST

### Patent Literature

Patent Literature 1: WO 2014/017208 A1

### SUMMARY OF INVENTION

An object of the present disclosure is to provide an airflow control system, a control method, and a program, all of which allow a person to visually recognize the reachable range of an airflow.

An airflow control system according to an aspect of the present disclosure includes an air blower, a supplier, a lighting fixture, and a controller. The air blower has an outlet port, from which an airflow with directivity is allowed to blow out. The supplier may supply the airflow blowing out from the outlet port with a functional component to be eventually emitted into the air. The lighting fixture may emit light having directivity in a direction aligned with a direction in which the airflow blows out from the outlet port of the air blower. The controller controls the air blower and the lighting fixture.

An airflow control system according to another aspect of the present disclosure includes an air blower, a supplier, a lighting fixture, and a controller. The air blower has an outlet port, from which an airflow with directivity is allowed to blow out. The supplier may supply the airflow blowing out from the outlet port with a functional component to be eventually emitted into the air. The lighting fixture may emit light with directivity. The controller controls the air blower and the lighting fixture. The air blower includes a cylindrical member. The cylindrical member has an inlet port for a gas at a first end and the outlet port at a second end. The lighting fixture is disposed outside the cylindrical member. The lighting fixture is arranged such that at a predetermined distance from the outlet port of the air blower, a center axis of the outlet port of the air blower intersects with an optical axis of the lighting fixture.

A control method according to still another aspect of the present disclosure includes: controlling an air blower to allow an airflow with directivity to blow out from an outlet port of the air blower; and having light with directivity emitted from a lighting fixture in a direction aligned with a direction in which the airflow is allowed to blow out from the air blower.

A program according to yet another aspect of the present disclosure is designed to cause a computer system to perform the control method described above.

### BRIEF DESCRIPTION OF DRAWINGS

FIG. 1 illustrates how an airflow control system according to a first embodiment may be used;

FIG. 2 is a partially cutaway perspective view of an air blower and a lighting fixture included in the airflow control system;

FIG. 3 illustrates a configuration for the airflow control system;

FIG. 4 is an exploded perspective view of the air blower included in the airflow control system;

FIG. 5A is a plan view of a fan included in the air blower of the airflow control system;

FIG. 5B is a plan view of a first rectifier included in the air blower of the airflow control system;

FIG. 5C is a plan view of a second rectifier included in the air blower of the airflow control system;

FIG. 6A shows the distribution of flow velocities in the air blower of the airflow control system;

FIG. 6B shows the distribution of flow velocities in an air blower included in an airflow control system according to a comparative example;

FIG. 7 illustrates how an airflow control system according to a second embodiment may be used;

FIG. 8 illustrates how an airflow control system according to a third embodiment may be used;

FIG. 9 illustrates a configuration for the airflow control system;

FIG. 10A is a cross-sectional view illustrating a situation where the light emitted from the lighting fixture of the airflow control system has a light distribution with a narrow angle;

FIG. 10B is a cross-sectional view illustrating a situation where the light emitted from the lighting fixture of the airflow control system has a light distribution with a wide angle; and

FIG. 11 illustrates how an airflow control system according to a fourth embodiment may be used.

### DESCRIPTION OF EMBODIMENTS

The drawings to be referred to in the following description of first to fourth embodiments are all schematic representations. Thus, the ratio of the dimensions (including thicknesses) of respective constituent elements illustrated on the drawings does not always reflect their actual dimensional ratio.

### First Embodiment

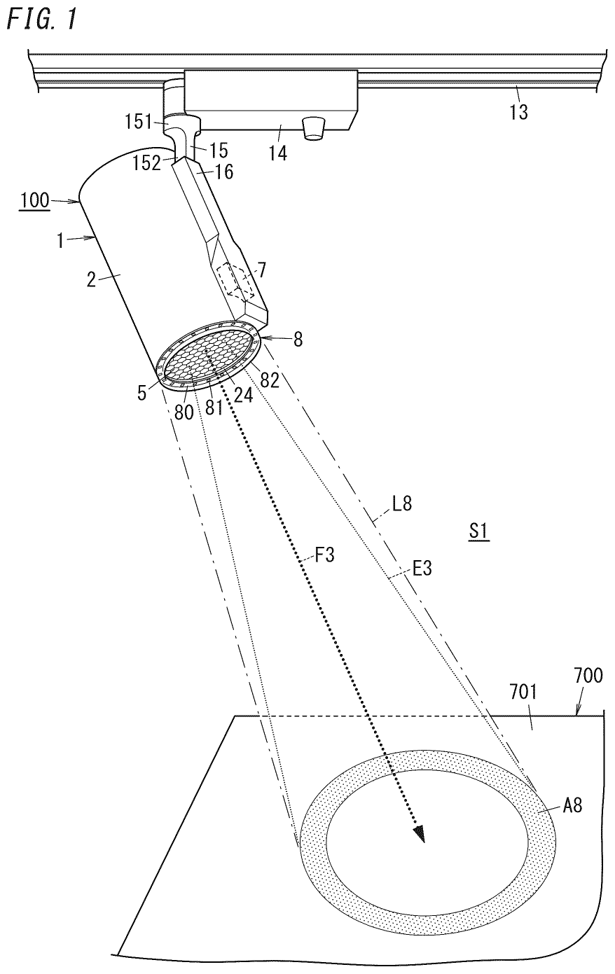

An airflow control system 100 and control method according to a first embodiment will now be described with reference to FIGS. 1-5C.

### (1) Overview

The airflow control system 100 may be used, for example, in space zoning at a facility. As used herein, the “space zoning” refers to air zoning, which means creating an air environment in a particular area within a target space S1 without putting any physical wall such as a building wall or a partition.

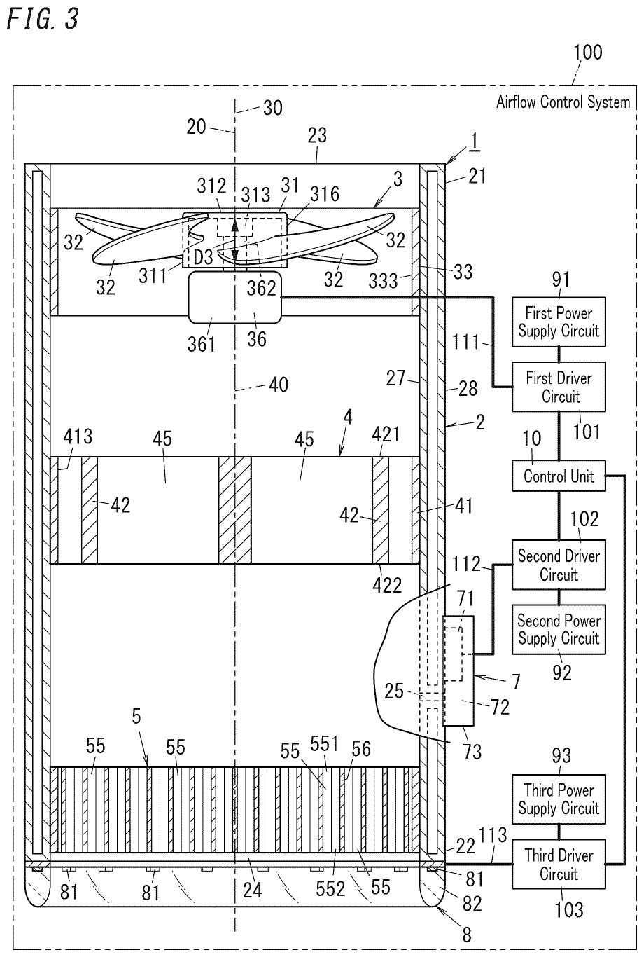

As shown in FIG. 1, the airflow control system 100 includes an air blower 1, a supplier 7, a lighting fixture 8, and a controller 10 (refer to FIG. 3). The air blower 1 has an outlet port 24, from which an airflow with directivity is allowed to blow out. The supplier 7 may supply the airflow blowing out from the outlet port 24 with a functional component to be eventually emitted into the air. The lighting fixture 8 may emit light L8 having directivity in a direction aligned with a direction F3 in which the airflow blows out from the outlet port 24 of the air blower 1. The controller 10 controls the air blower 1 and the lighting fixture 8.

The airflow (air) blowing out from the outlet port 24 of the air blower 1 in the airflow control system 100 into the target space S1 is a jet and a directional airflow with a degree of straightness. The airflow is a stream of the air. The facility may be an office building, for example. The target space S1 may be, for example, a non-territorial office (which is called a “free-address office” in Japan) in the office building. However, the target space S1 does not have to be a non-territorial office. Alternatively, the target space S1 may also be a space such as an assembly room. The target space S1 may be, for example, the space under the ceiling within the facility. In the target space S1, desks 700, chairs, and other objects are arranged as pieces of furniture and fittings which may be used by persons.

Examples of the facilities include not only office buildings but also hotels, hospitals, educational institutions, single-family dwelling houses, multi-family dwelling houses (including dwelling units and common areas), stores, commercial facilities, art museums, and museums. Optionally, the facility does not have to be a building alone but may also be a premise with the building. Examples of such facilities include factories, public parks, amusement facilities, theme parks, airports, railway stations, and domed ballparks.

### (2) Details

As shown in FIG. 1, the airflow control system 100 includes the air blower 1, the supplier 7, the lighting fixture 8, and the controller 10 (refer to FIG. 3).

The airflow control system 100 may be installed onto, for example, a wiring duct 13 mounted on the ceiling within the facility. The airflow control system 100 includes an installer 14, an arm 15, and a coupler 16. The installer 14 is slidably attached onto the wiring duct 13. The arm 15 has a first end 151 and a second end 152. In this arm 15, the first end 151 of the arm 15 is coupled to the installer 14. The coupler 16 couples the second end 152 of the arm 15 to the cylindrical member 2 of the air blower 1. Attaching the installer 14 onto the wiring duct 13 electrically connects the airflow control system 100 to an AC power supply connected to the wiring duct 13. As shown in FIG. 3, the airflow control system 100 further includes a first power supply circuit 91, a first driver circuit 101, a second power supply circuit 92, a second driver circuit 102, a third power supply circuit 93, and a third driver circuit 103. The first power supply circuit 91 converts, for example, an AC voltage supplied from the AC power supply into a first DC voltage and outputs the first DC voltage. The first driver circuit 101 receives the first DC voltage supplied from the first power supply circuit 91 to drive a motor 36 of a fan 3 of the air blower 1. The second power supply circuit 92 converts, for example, the AC voltage supplied from the AC power supply into a second DC voltage and outputs the second DC voltage. The second driver circuit 102 receives the second DC voltage supplied from the second power supply circuit 92 to drive the supplier 7. The third power supply circuit 93 converts, for example, the AC voltage supplied from the AC power supply into a third DC voltage and outputs the third DC voltage. The third driver circuit 103 receives the third DC voltage supplied from the third power supply circuit 93 to drive the lighting fixture 8. In the airflow control system 100, the first power supply circuit 91, the first driver circuit 101, the second power supply circuit 92, the second driver circuit 102, the third power supply circuit 93, the third driver circuit 103, and the controller 10 may be housed, for example, in the housing of the installer 14 (refer to FIG. 1). The arm 15 and the coupler 16 (refer to FIG. 1) each have a space into which a part of a first electric wire 111 that connects the first driver circuit 101 to the motor 36, a part of a second electric wire 112 that connects the second driver circuit 102 to the supplier 7, and a part of a third electric wire 113 that connects the third driver circuit 103 to the lighting fixture 8 may be passed.

### (2.1) Air Blower

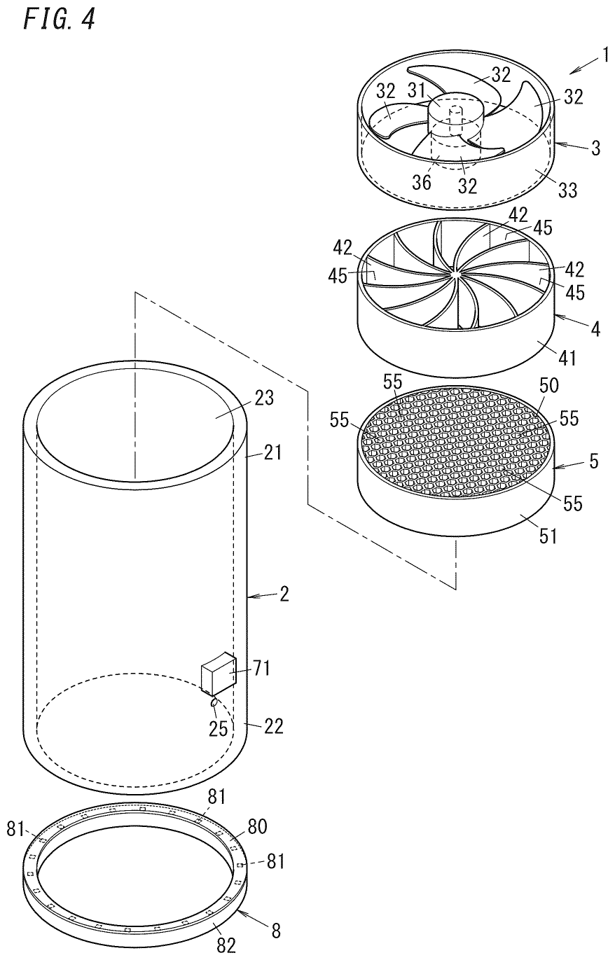

As shown in FIGS. 3 and 4, the air blower 1 includes the cylindrical member 2, the fan 3, a first rectifier 4, and a second rectifier 5. The air blower 1 may control the velocity of the airflow blowing out from the outlet port 24 by adjusting the number of revolutions of the fan 3. The number of revolutions of the fan 3 varies as the magnitude of the voltage supplied from the first driver circuit 101 to the motor 36 changes. The first driver circuit 101 is controlled by the controller 10 to change the magnitude of the voltage supplied to the motor 36.

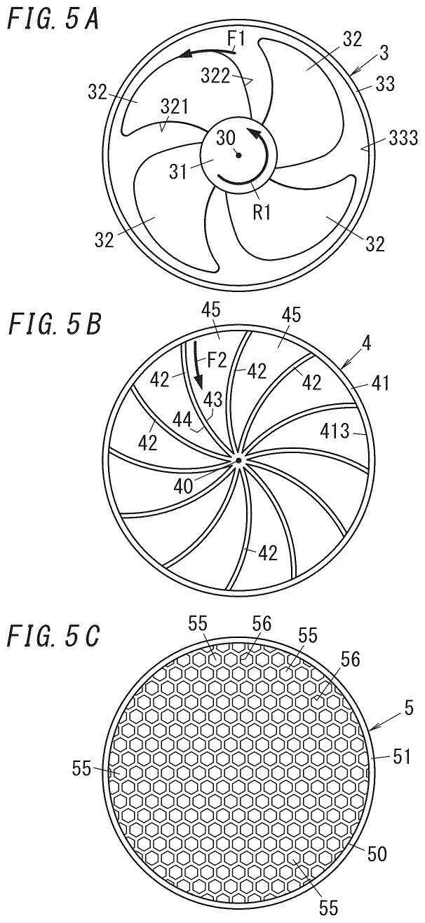

The cylindrical member 2 may have, for example, a circular cylindrical shape. The cylindrical member 2 has an inlet port 23, through which a gas is introduced, at a first end 21 thereof and has the outlet port 24 at a second end 22 thereof. The fan 3 is disposed inside the cylindrical member 2. The first rectifier 4 is located, in an axial direction D3 of the fan 3, between the fan 3 and the outlet port 24. The first rectifier 4 changes the flowing direction of an airflow F1 (refer to FIG. 5A) swirling. The second rectifier 5 is located, in the axial direction D3 of the fan 3, between the first rectifier 4 and the outlet port 24. The second rectifier 5 unifies the flowing directions of the airflows into a direction aligned with the axial direction D3 of the fan 3. The first rectifier 4 includes a cylindrical portion 41 having a circular cylindrical shape and a plurality of fins (stator vanes) 42. Each of the plurality of fins 42 has an arc shape (refer to FIG. 5B) when viewed in the axial direction D3 of the fan 3. The plurality of fins 42 protrude from the inner circumferential surface 413 of the cylindrical portion 41 toward the center axis 40 of the cylindrical portion 41 and are arranged side by side along the inner circumference of the cylindrical portion 41 as shown in FIG. 5B. The second rectifier 5 has a plurality of flow channels 55 aligned with the axial direction D3 of the fan 3 as shown in FIGS. 3, 4, and 5C.

As shown in FIGS. 1-4, the cylindrical member 2 has a circular cylindrical shape. The cylindrical member 2 has the first end 21 and the second end 22 as shown in FIGS. 3 and 4. The cylindrical member 2 has the inlet port 23 for a gas at the first end 21 and has the outlet port 24 for the gas at the second end 22. A material for the cylindrical member 2 may be, but does not have to be, a metal or a resin, for example.

The fan 3 (refer to FIGS. 3, 4, and 5A) lets the air flowing in the cylindrical member 2 through the inlet port 23 thereof blow toward the outlet port 24 of the cylindrical member 2. The fan 3 is an electric axial-flow fan rotatable around the center axis 30 of rotation of a rotator (hub) 31 included in the fan 3. The fan 3 may move the air flowing into a fan housing 33 while helically rotating the air around the rotator 31 to cause the air to flow to a downstream point. As used herein, the “downstream point” refers to a downstream point when viewed in the direction in which the air flows.

The fan 3 is disposed inside the cylindrical member 2. The fan 3 is disposed closer to the first end 21 of the cylindrical member 2 rather than to the second end 22 of the cylindrical member 2 in the axial direction of the cylindrical member 2. In the axial direction of the cylindrical member 2, the distance from the fan 3 to the inlet port 23 is shorter than the distance from the fan 3 to the outlet port 24.

The fan 3 includes the rotator 31, a plurality of (e.g., four) blades (rotary vanes) 32, the fan housing 33, the motor 36, a motor attachment, and a plurality of (e.g., three) beams. A material for the rotator 31, the plurality of blades 32, and the fan housing 33 of the fan 3 may be, for example, a resin or a metal.

The rotator 31 is rotatable around the center axis 30 of rotation. When viewed in the axial direction D3 of the fan 3, the outer edge of the rotator 31 has a circular shape. The rotator 31 is disposed inside the cylindrical member 2 to be coaxial with the cylindrical member 2. As used herein, the expression “the rotator 31 is disposed to be coaxial with the cylindrical member 2” means that the rotator 31 is disposed such that the center axis 30 of rotation of the rotator 31 is aligned with the center axis 20 of the cylindrical member 2. In the axial direction D3 of the fan 3, the rotator 31 is shorter in length than the cylindrical member 2. The axial direction D3 of the fan 3 is a direction aligned with the center axis 30 of rotation. The rotator 31 has the shape of a bottomed cylinder having a circular cylindrical portion 311 and a bottom wall 312 and is arranged such that the bottom wall 312 faces the inlet port 23 of the cylindrical member 2. The rotator 31 includes a boss 313 protruding away from the inlet port 23 of the cylindrical member 2 from a central portion of the bottom wall 312.

The plurality of blades 32 are arranged between the rotator 31 and the fan housing 33 and rotate along with the rotator 31. The plurality of blades 32 are connected to the rotator 31 and protrude from an outer circumferential surface 316 of the rotator 31 toward an inner circumferential surface 27 of the cylindrical member 2. When viewed in the axial direction D3 of the fan 3, the plurality of blades 32 radially protrude from the rotator 31. Each of the plurality of blades 32 is arranged such that a gap is left between the blade 32 and the inner circumferential surface 333 of the fan housing 33 when viewed in the axial direction D3 of the fan 3. In other words, the fan 3 has a gap between each of the plurality of blades 32 and the inner circumferential surface 333 of the fan housing 33. The plurality of blades 32 are arranged at regular intervals when viewed in the axial direction D3 of the fan 3. As used herein, the phrase “arranged at regular intervals” refers to not only a situation where the blades 32 are arranged at exactly the same intervals but also a situation where the difference between the intervals and a predefined interval falls within a predetermined tolerance range (e.g., within ±10% of the predefined interval). In each of the plurality of blades 32, a first end 321 (refer to FIG. 5A) thereof facing the inlet port 23 is located forward of a second end 322 (refer to FIG. 5A) thereof facing the outlet port 24 in a rotational direction R1 (refer to FIG. 5A) of the rotator 31 of the fan 3.

The fan housing 33 houses the rotator 31 and the plurality of blades 32 to make the rotator 31 and the plurality of blades 32 rotatable. The fan housing 33 has a circular cylindrical shape. The outside diameter of the fan housing 33 is substantially equal to the inside diameter of the cylindrical member 2. In the fan 3, the fan housing 33 may be fixed to the cylindrical member 2, for example.

The motor 36 drives the rotator 31 in rotation. More specifically, the motor 36 rotates the rotator 31 around the center axis 30 of rotation of the rotator 31. The motor 36 may be, for example, a DC motor. The motor 36 is driven by the first driver circuit 101. The motor 36 includes a motor body 361 and a rotary shaft 362 partially protruding from the motor body 361. In the motor 36, the rotary shaft 362 is coupled to the rotator 31. The rotary shaft 362 of the motor 36 is fixed to the boss 313 of the rotator 31.

To the motor attachment, the motor body 361 of the motor 36 is attached. When viewed in the axial direction D3 of the fan 3, the motor attachment may be located inside the outer edge of the rotator 31. However, this is only an example and should not be construed as limiting. Alternatively, when viewed in the axial direction D3 of the fan 3, the motor attachment may overlap in its entirety with the entire rotator 31, for example.

The plurality of (e.g., three) beams connect the motor attachment to the fan housing 33. The plurality of beams are arranged at regular intervals along the outer edge of the motor attachment.

The first rectifier 4 is located, in the axial direction D3 of the fan 3, between the fan 3 and the outlet port 24 as shown in FIG. 3. The first rectifier 4 changes the flowing direction of the airflow F1 (refer to FIG. 5A) swirling downstream of the fan 3. More specifically, the first rectifier 4 turns the airflow F1 swirling downstream of the fan 3 into an airflow F2 (refer to FIG. 5B) flowing toward the center of the fan 3. In addition, the first rectifier 4 also forms a flow velocity distribution in which the velocity of an airflow in a first region is higher than the velocity of an airflow in a second region downstream of the first rectifier 4 when viewed in the axial direction D3 of the fan 3. As used herein, the “velocity” of the airflow refers to a velocity as measured in the axial direction D3 of the fan 3. The first region herein refers to a region (inner region) located closer to the center axis 20 of the cylindrical member 2 rather than to the inner circumferential surface 27 of the cylindrical member 2. The second region herein refers to a region (outer region) located closer to the inner circumferential surface 27 of the cylindrical member 2 rather than to the center axis 20 of the cylindrical member 2.

The first rectifier 4 includes a cylindrical portion 41 having a circular cylindrical shape and a plurality of (e.g., twelve) fins 42 as shown in FIGS. 3, 4, and 5B.

The outside diameter of the cylindrical portion 41 is substantially equal to the inside diameter of the cylindrical member 2. The inside diameter of the cylindrical portion 41 is substantially equal to the inside diameter of the fan housing 33.

Each of the plurality of fins 42 has an arc shape when viewed in the axial direction D3 of the fan 3. The plurality of fins 42 protrude from the inner circumferential surface 413 of the cylindrical portion 41 toward the center axis 40 of the cylindrical portion 41 and are arranged side by side along the inner circumference of the cylindrical portion 41. Each of the plurality of fins 42 has a first end 421 facing the inlet port 23 in the axial direction D3 of the fan 3 and a second end 422 facing the outlet port 24 in the axial direction D3 of the fan 3.

The plurality of fins 42 are arranged between the inner circumferential surface 413 of the cylindrical portion 41 and the center axis of the cylindrical portion 41 to be parallel to the axial direction D3 of the fan 3. In each of the plurality of fins 42, the first end 421 and the second end 422 thereof overlap with each other when viewed in the axial direction D3 of the fan 3.

The respective ends, adjacent to the cylindrical portion 41, of the plurality of fins 42 are arranged at regular intervals along the inner circumference of the cylindrical portion 41. As used herein, the phrase “arranged at regular intervals” refers to not only a situation where the respective ends of the fins 42 are arranged at exactly the same intervals but also a situation where the difference between the intervals and a predefined interval falls within a predetermined tolerance range (e.g., within ±10% of the predefined interval). The first rectifier 4 has a plurality of (e.g., twelve) flow channels 45, each of which is surrounded with two adjacent fins 42 out of the plurality of fins 42 and the cylindrical portion 41. When viewed in the axial direction D3 of the fan 3, the width, measured along the inner circumference of the cylindrical portion 41, of each flow channel 45 narrows from the inner circumferential surface 413 of the cylindrical portion 41 toward the center axis 40 of the cylindrical portion 41.

When measured in the axial direction D3 of the fan 3, the length of each of the plurality of fins 42 may be equal to the length of the cylindrical portion 41. However, the length of each of the plurality of fins 42 does not have to be equal to the length of the cylindrical portion 41 but may be longer or shorter than the length of the cylindrical portion 41, whichever is appropriate.

Each of the plurality of fins 42 has a first surface 43 intersecting with the inner circumference of the cylindrical member 2 and a second surface 44 intersecting with the inner circumference of the cylindrical member 2 and located opposite from the first surface 43. The first surface 43 is a surface located backward of the second surface 44 in the rotational direction R1 of the rotator 31 (refer to FIG. 5A). The second surface 44 is a surface located forward of the first surface 43 in the rotational direction R1 of the rotator 31. The first surface 43 is a curved concave surface. The second surface 44 is a curved convex surface.

A material for the first rectifier 4 may be, but does not have to be, a metal, and may also be a resin.

The second rectifier 5 (refer to FIGS. 3, 4, and 5C) is located, in the axial direction D3 of the fan 3, between the first rectifier 4 and the outlet port 24 of the cylindrical member 2. The second rectifier 5 adjusts, downstream of the first rectifier 4, the flow velocity distribution of the airflow coming from the first rectifier 4. The second rectifier 5 has a plurality of flow channels 55 aligned with the axial direction D3 of the fan 3. Each of the plurality of flow channels 55 has an inlet 551 facing the first rectifier 4 and an outlet 552 facing the outlet port 24 of the cylindrical member 2. In each of the plurality of flow channels 55, the inlet 551 and the outlet 552 have the same shape. In each of the plurality of flow channels 55, the inlet 551 and the outlet 552 have the same size. The second rectifier 5 includes a rectifying grid 50 and a cylindrical portion 51 surrounding the rectifying grid 50 and having a circular cylindrical shape. The rectifying grid 50 includes a plurality of partitions 56 partitioning, from each other, any two adjacent flow channels 55 out of the plurality of flow channels 55. The plurality of partitions 56 are arranged in the axial direction D3 of the fan 3. The rectifying grid 50 has the shape of a honeycomb grid. In this embodiment, when viewed in the axial direction D3 of the fan 3, the inlet 551 and outlet 552 of each of the plurality of flow channels 55 each have a regular hexagonal shape. In other words, each of the plurality of flow channels 55 has a hexagonal prism shape.

The outside diameter of the cylindrical portion 51 is substantially equal to the inside diameter of the cylindrical member 2. The second rectifier 5 is arranged in the cylindrical member 2 such that the center axis of the cylindrical portion 51 is aligned with the center axis 20 of the cylindrical member 2.

A material for the second rectifier 5 may be, but does not have to be, a resin, and may also be a metal, for example.

### (2.2) Supplier

The supplier 7 (refer to FIGS. 1 and 3) may supply a functional component, which will be eventually emitted into the air, to the airflow that is going to blow out from the outlet port 24. More specifically, the supplier 7 includes a generator 71 and a functional component carrying flow channel 72. The generator 71 may generate, for example, mist containing the functional component. The functional component carrying flow channel 72 communicates with the space between the first rectifier 4 and the outlet port 24 inside the cylindrical member 2. Examples of the functional components include a deodorization component, a fragrance component, a disinfection component, a sterilization component, a cosmetic component, and a pharmaceutical component. The supplier 7 is configured to supply the functional component from a functional material containing the functional component. Examples of such a functional material containing the functional component include a solution containing the functional component.

The generator 71 includes: an atomizer for atomizing, for example, a solution containing the functional component; and an energy supply device for giving energy to the solution to allow the atomizer to atomize the solution. The energy supply device may be, but does not have to be, an ultrasonic vibrator, for example, and may also be a surface acoustic wave (SAW) device, for example. The generator 71 is driven by the second driver circuit 102.

In the air blower 1, the cylindrical member 2 has a communication hole 25 (refer to FIGS. 3 and 4) which penetrates through the cylindrical member 2 between the first end 21 and the second end 22 thereof and extends in a direction intersecting with the axial direction of the cylindrical member 2. The functional component carrying flow channel 72 communicates with the outlet port 24 of the cylindrical member 2 via the communication hole 25. The functional component carrying flow channel 72 may be formed by, for example, attaching a flow channel forming member 73 (refer to FIG. 3) onto the cylindrical member 2. The functional component carrying flow channel 72 is formed between the flow channel forming member 73 and the outer circumferential surface (side surface) 28 of the cylindrical member 2 and communicates with the space inside the cylindrical member 2 via the communication hole 25 of the cylindrical member 2.

The supplier 7 has the mist containing the functional component that has been generated by the generator 71 supplied, via the functional component carrying flow channel 72 and the communication hole 25, to the airflow blowing out from the outlet port 24. The supplier 7 may cause the mist containing the functional component to rush into the airflow inside the cylindrical member 2 and thereby have the mist containing the functional component carried inside the cylindrical member 2. Alternatively, the supplier 7 may include a fan that feeds the mist containing the functional component into the cylindrical member 2. The functional component carrying flow channel 72 does not have to be formed out of the flow channel forming member 73. Alternatively, the functional component carrying flow channel 72 may also be implemented as a tubular member which has a first end and a second end and of which the first end is connected to the generator 71 and the second end is disposed inside the cylindrical member 2 through the communication hole 25.

### (2.3) Lighting Fixture

As shown in FIG. 1, the lighting fixture 8 may emit light L8 having directivity in a direction aligned with a direction F3 in which the airflow blows out from the outlet port 24 of the air blower 1. The lighting fixture 8 irradiates, for example, the upper surface 701 of a desk 700 with the light L8. The upper surface 701 of the desk 700 is arranged to fall within the reachable range of the airflow coming from the air blower 1 and the functional component coming from the supplier 7 at a facility.

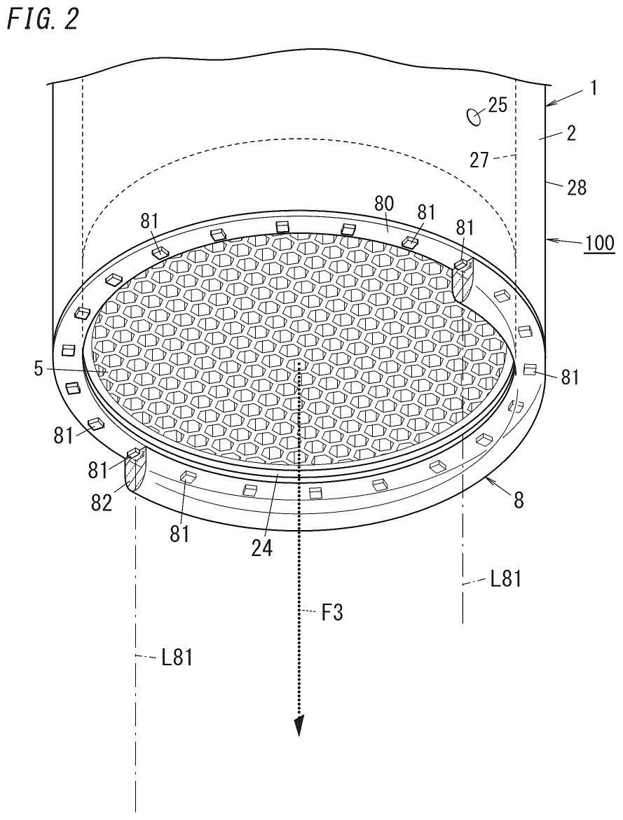

As shown in FIG. 2, the lighting fixture 8 may include, for example, a mount board 80, a plurality of (e.g., 22 in the example illustrated in FIG. 2) light sources 81 mounted on the mount board 80, and a lens 82 for controlling the light distribution of the plurality of light sources 81.

The mount board 80 may be, for example, a printed wiring board. The mount board 80 may have, for example, a ring shape and is laid on top of the periphery of the outlet port 24 of the cylindrical member 2.

When viewed in a direction aligned with the center axis of the outlet port 24 of the air blower 1 (i.e., in the axial direction D3 of the fan 3), the plurality of light sources 81 are arranged at regular intervals to be spaced from each other. As used herein, the phrase “arranged at regular intervals” refers to not only a situation where the light sources 81 are arranged at exactly the same intervals but also a situation where the difference between the intervals and a predefined interval falls within a predetermined tolerance range (e.g., within ±10% of the predefined interval).

Each of the plurality of light sources 81 may include, for example, a light-emitting diode (LED). The LED may emit white light. The white light emitted from the LED may have a correlated color temperature equal to or higher than 2700 K and equal to or lower than 6000 K, for example. The LED may be, for example, a surface-mounted LED including a blue LED chip, a green LED chip, a red LED chip, and a package that houses the blue LED chip, the green LED chip, and the red LED chip. The blue LED chip emits a blue ray. The green LED chip emits a green ray. The red LED chip emits a red ray.

The lens 82 collimates the light rays emitted from the plurality of light sources 81. The lens 82 is a plano-convex cylindrical lens and provided along the entire circumference of the ringlike mount board 80. The lens 82 has a bullet-shaped cross section taken along a plane aligned with the thickness of the mount board 80. The light L8 emitted from the lighting fixture 8 is a bundle of the light rays emitted from the plurality of light sources 81 which has been collimated by the lens 82. The lighting fixture 8 is arranged to surround the outlet port 24 of the cylindrical member 2 of the air blower 1 such that the respective optical axes L81 of the plurality of light sources 81 are parallel to the center axis of the outlet port 24 of the air blower 1. In this embodiment, the respective optical axes L81 of the plurality of light sources 81 are parallel to the center axis of the outlet port 24 of the air blower 1. However, the respective optical axes L81 of the plurality of light sources 81 do not have to be exactly parallel to the center axis of the outlet port 24 of the air blower 1 but the angle formed between the respective optical axes L81 of the plurality of light sources 81 and the center axis of the outlet port 24 of the air blower 1 may be equal to or less than 10 degrees.

The lighting fixture 8 is driven by the third driver circuit 103 (refer to FIG. 3). The third driver circuit 103 may include, for example, a blue LED driver, a green LED driver, and a red LED driver. The blue LED driver drives the plurality of (e.g., 22) blue LED chips. The green LED driver drives the plurality of (e.g., 22) green LED chips. The red LED driver drives the plurality of (e.g., 22) red LED chips. The lighting fixture 8 may project, as lighting light, any one of white light, blue light, green light, or red light or a mixture of two or more selected from these types of light by having the blue LED driver, the green LED driver, and the red LED driver controlled by the controller 10 (refer to FIG. 3). That is to say, the lighting fixture 8 may project, as either colored lighting light or white light, light in a color corresponding to an arbitrary chromaticity point falling, in an xy chromaticity diagram of the XYZ color system, within the triangular range, of which the respective vertices are defined by a chromaticity point of the blue ray emitted from the blue LED chip, a chromaticity point of the green ray emitted from the green LED chip, and a chromaticity point of the red ray emitted from the red LED chip. The white light is preferably light with a chromaticity corresponding to a chromaticity point on the blackbody locus in the xy chromaticity diagram of the XYZ color system.

### (2.4) Controller

The controller 10 (refer to FIG. 3) controls the air blower 1 and the supplier 7. The controller 10 also controls the lighting fixture 8. The controller 10 further controls the fan 3 by controlling the first driver circuit 101. The controller 10 also controls the supplier 7 by controlling the second driver circuit 102. The controller 10 further controls the lighting fixture 8 by controlling the third driver circuit 103.

Examples of control of the air blower 1 by the controller 10 include starting turning the fan 3, stopping turning the fan 3, and controlling the number of revolutions of the fan 3. The controller 10 may control the velocity of the airflow blowing out from the outlet port 24 of the air blower 1 by adjusting the drive voltage of the (motor 36 of the) fan 3 and thereby controlling the number of revolutions of the fan 3. The number of revolutions of the fan 3 and the volume of the air supplied by the fan 3 vary as the drive voltage changes. Specifically, as the drive voltage increases, the number of revolutions of the fan 3 and the volume of the air supplied by the fan 3 also increase. In the air blower 1, as the number of revolutions of the fan 3 increases, the velocity of the airflow blowing out from the outlet port 24 increases.

Examples of the control of the supplier 7 by the controller 10 include starting atomizing the solution at the generator 71, stopping atomizing the solution, and controlling the rate of atomizing the solution.

The controller 10 may supply the airflow blowing out from the outlet port 24 with the functional component to be eventually emitted into the air by controlling the air blower 1 and the supplier 7. The controller 10 may also control the timing to supply the airflow blowing out from the outlet port 24 with the functional component to be eventually emitted into the air by controlling the air blower 1 and the supplier 7.

Examples of control of the lighting fixture 8 by the controller 10 include controlling the color of the lighting light, controlling the timing to turn ON and OFF the lighting fixture 8, controlling the timing to flash the lighting fixture 8, and controlling the illuminance of the lighting light. The color of the lighting light may be either color white or a color different from the color white (e.g., the color red, green, or blue).

The controller 10 includes a computer system. The computer system may include a processor and a memory as principal hardware components thereof. The functions of the controller 10 may be performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits such as an IC or an LSI include integrated circuits called a “system LSI,” a “very-large-scale integrated circuit (VLSI),” and an “ultra-large-scale integrated circuit (ULSI).” Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

### (3) Operation of Airflow Control System

### (3.1) Operation of Air Blower

In the air blower 1, the rotator 31 and the plurality of blades 32 of the fan 3 turn in the predetermined rotational direction R1 (refer to FIG. 5A), thereby causing the air to rush into the fan 3 through the inlet port 23 of the cylindrical member 2. As a result, an airflow F1 (refer to FIG. 5A) swirling along the inner circumferential surface 27 of the cylindrical member 2 is generated inside the cylindrical member 2 downstream of the fan 3 inside the cylindrical member 2. The swirling airflow F1 is a spirally turning, three-dimensional airflow.

In the air blower 1, the airflow F1 (refer to FIG. 5A) generated downstream of the fan 3 which is swirling, around the inner circumferential surface 27 of the cylindrical member 2, along the inner circumferential surface 27 has its flowing direction changed, by the first rectifier 4, to a direction pointing toward the center axis 40 of the first rectifier 4. More specifically, in the first rectifier 4, the airflow F1 (refer to FIG. 5A) swirling along the inner circumferential surface 27 of the cylindrical member 2 collides against the fins 42, thereby turning the airflow F1 into an airflow F2 (refer to FIG. 5B) flowing toward the center axis 40 of the first rectifier 4. In other words, the first rectifier 4 collects, toward the center axis 40 of the first rectifier 4, the airflow F1 generated by the fan 3 which is swirling along the inner circumferential surface 27 of the cylindrical member 2 and thus forms, downstream of the first rectifier 4, a flow velocity distribution in which the velocity of an airflow in the first region is higher than the velocity of an airflow in the second region. In sum, the air blower 1 may have the first rectifier 4 form a velocity distribution in which the velocity of the airflow is relatively high inside and relatively low outside. In this case, the velocity of the airflow is a velocity measured in the axial direction D3 of the fan 3. The first region herein refers to a region (inner region) located closer to the center axis 20 of the cylindrical member 2 rather than to the inner circumferential surface 27 of the cylindrical member 2 between the center axis 20 of the cylindrical member 2 and the inner circumferential surface 27 of the cylindrical member 2. The second region herein refers to a region (outer region) located closer to the inner circumferential surface 27 of the cylindrical member 2 rather than to the center axis 20 of the cylindrical member 2 between the center axis 20 of the cylindrical member 2 and the inner circumferential surface 27 of the cylindrical member 2.

In the air blower 1, the second rectifier 5 provided downstream of the first rectifier 4 changes the flowing direction of the airflow coming from the first rectifier 4 into the direction aligned with the axial direction D3 of the fan 3.

In the air blower 1, an airflow rectified by the second rectifier 5 flows out from the outlet port 24 of the cylindrical member 2.

In the air blower 1, when the fan 3 is driven, an airflow flowing downstream of the fan 3 is rectified by the first rectifier 4 and the second rectifier 5 to blow out from the outlet port 24 of the cylindrical member 2.

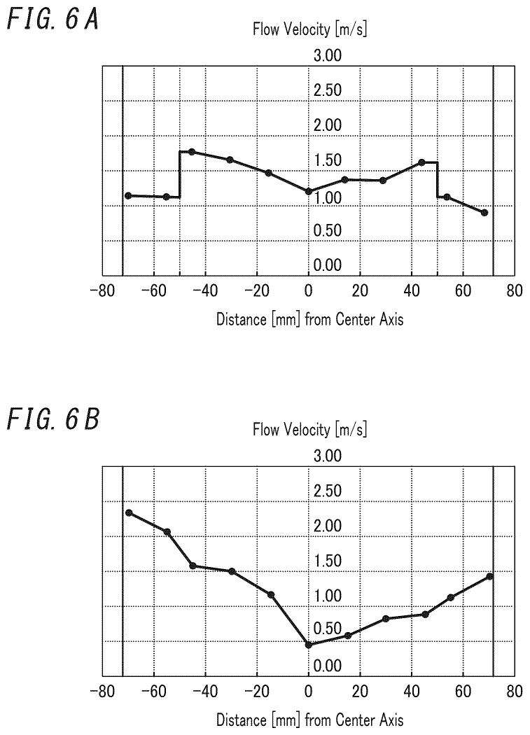

FIG. 6A shows a flow velocity distribution in the vicinity of the outlet port 24 of the cylindrical member 2 of the air blower 1. FIG. 6A shows the flow velocity distribution in the air blower 1 of the airflow control system 100 according to the first embodiment in a situation where the air volume of the fan 3 is set at 70 m³/h and the structural parameters are set as follows. Meanwhile, FIG. 6B shows a flow velocity distribution in an air blower according to a comparative example including neither the first rectifier 4 nor the second rectifier 5.

<Structure parameters>
Inside diameter of the cylindrical member 2: 144 mm;
Number of fins 42 of the first rectifier 4: 12;
Length of each fin 42 in the axial direction D3 of the fan 3: 50 mm;
Inlet 551 of each flow channel 55 in the second rectifier 5: regular hexagon having a distance of 8 mm between opposite sides;
Outlet 552 of each flow channel 55 in the second rectifier 5: regular hexagon having a distance of 8 mm between opposite sides; and
Length of each flow channel 55 in the second rectifier 5: 30 mm.

FIGS. 6A and 6B each show the flow velocity distribution at a cross section including the center axis 20 of the cylindrical member 2. In FIGS. 6A and 6B, the abscissa indicates the distance as measured from the center axis 20 of the cylindrical member 2, and the ordinate indicates the flow velocity. The abscissa is “positive” on the right of the center axis 20 and “negative (− sign)” on the left of the center axis. These “positive” and “negative (−)” signs are given to distinguish a distance to an arbitrary location on the right of the center axis 20 and a distance to an arbitrary location on the left of the center axis 20 from each other.

In the air blower according to the comparative example, the flow velocity increases as the distance from the center of the outlet port 24 increases as shown in FIG. 6B. In contrast, the air blower 1 of the airflow control system 100 according to the first embodiment may provide a flow velocity distribution in which the flow velocity in the inner region of the outlet port 24 is higher than the flow velocity in the outer region of the outlet port 24 as shown in FIG. 6A. The air blower 1 may blow out double jet streams, namely, a first jet stream blowing out from the inner region of the outlet port 24 and a second jet stream blowing out from the outer region of the outlet port 24.

The air blower 1 may increase the degree of directivity of the airflow (jet stream) blowing out from the outlet port 24 of the cylindrical member 2 and may reduce the diffusion of the airflow. Thus, the air blower 1 may carry the airflow toward a local spot in a particular area within the target space S1.

### (3.2) Operation of Controller

The controller 10 may control, for example, the air blower 1 to let an airflow with directivity blow out from the outlet port 24 of the air blower 1 and also make the lighting fixture 8 emit the light L8 having directivity in a direction aligned with the direction F3 in which the airflow blows out from the air blower 1.

In addition, the controller 10 also makes, while controlling the air blower 1 to let the airflow with directivity blow out from the outlet port 24 of the air blower 1, the supplier 7 supply the functional component to the airflow.

When making the supplier 7 supply the functional component to the airflow, the controller 10 may have the functional component supplied to the airflow either temporarily (instantaneously) or continuously, whichever is appropriate. If the functional component to be supplied from the supplier 7 to the airflow is a fragrance component, for example, the controller 10 may make the supplier 7 supply the functional component to the airflow intermittently. On the other hand, if the functional component to be supplied from the supplier 7 to the airflow is a deodorization component, a disinfection component, a sterilization component, a cosmetic component, or a pharmaceutical component, for example, then the controller 10 may make the supplier 7 supply the functional component to the airflow continuously.

The controller 10 may also make, while controlling the air blower 1 to let the airflow with directivity blow out from the outlet port 24 of the air blower 1, the lighting fixture 8 emit the light L8 with directivity either intermittently or continuously, whichever is appropriate. Alternatively, the controller 10 may also control, while controlling the air blower 1 to let the airflow with directivity blow out from the outlet port 24 of the air blower 1 and making the supplier 7 supply the functional component to the airflow, the lighting fixture 8 to emit the light L8 with directivity. This allows the airflow control system 100 to have a sign, related to the reachable range of the airflow and the functional component on the upper surface 701 of the desk 700 in the target space S1 at the facility, presented (indicated) by the light L8 emitted from the lighting fixture 8. In the airflow control system 100, the outer periphery of the ringlike area A8 irradiated with the light L8 on the upper surface 701 of the desk 700 corresponds to the outer periphery of the range E3 that the airflow and the functional component have reached. As used herein, the range E3 that the airflow and the functional component have reached means a range on which an airflow having a velocity equal to or higher than a predetermined velocity impinges and also means a range, on which an airflow with a functional component having a concentration equal to or greater than a predetermined concentration impinges.

### (4) Control Method

A control method according to the first embodiment is a method for controlling a system including the air blower 1, the supplier 7, and the lighting fixture 8.

The control method according to the first embodiment is performed by the operation of the controller 10. This control method includes: controlling the air blower 1 to allow an airflow with directivity to blow out from the outlet port 24 of the air blower 1; and having light L8 with directivity emitted from the lighting fixture 8 in a direction aligned with the direction F3 in which the airflow is allowed to blow out from the air blower 1.

Alternatively, the control method may include having light L8 with directivity emitted from the lighting fixture 8 in a direction aligned with the direction F3 in which the airflow is allowed to blow out from the air blower 1 while controlling the air blower 1 to allow an airflow with directivity to blow out from the outlet port 24 of the air blower 1 and controlling the supplier 7 to have the functional component supplied from the supplier 7 to the airflow.

The control method according to the first embodiment is performed by causing a computer system to execute a program. The program is a (computer) program designed to cause the computer system to perform the control method.

### (5) Advantages

### (5.1) Airflow Control System

An airflow control system 100 according to the first embodiment includes an air blower 1, a supplier 7, a lighting fixture 8, and a controller 10. The air blower 1 has an outlet port 24, from which an airflow with directivity is allowed to blow out. The supplier 7 may supply the airflow blowing out from the outlet port 24 with a functional component to be eventually emitted into the air. The lighting fixture 8 may emit light L8 having directivity in a direction aligned with a direction F3 in which the airflow blows out from the outlet port 24 of the air blower 1. The controller 10 controls the air blower 1 and the lighting fixture 8; 8a; 8b.

The airflow control system 100 includes the air blower 1 having the outlet port 24, from which an airflow with directivity is allowed to blow out. This may reduce the diffusion of the airflow, and therefore, may reduce the diffusion of the airflow containing the functional component. The airflow control system 100 includes the supplier 7 and the controller 10, thus allowing the airflow blowing out into the target space S1 at a facility to contain the functional component. In addition, the airflow control system 100 may also reduce the diffusion of the airflow containing the functional component in the target space S1. As used herein, “to reduce the diffusion of the airflow containing the functional component” means increasing the degree of straightness of the airflow containing the functional component and thereby increasing the directivity thereof. The airflow control system 100 according to the first embodiment may reduce the chances of causing a decrease in the concentration of the functional component before the functional component reaches the target space to which the functional component should be supplied. Consequently, the airflow control system 100 according to the first embodiment may enhance the effect produced by the functional component.

The airflow control system 100 according to the first embodiment includes the lighting fixture 8 which may emit the light L8 having directivity in the direction aligned with the direction F3 in which the airflow is allowed to blow out from the outlet port 24 of the air blower 1. This allows the person to visually recognize the reachable range of the airflow. More specifically, the airflow control system 100 according to the first embodiment may have a sign, related to the reachable range of the airflow with directivity which has blown out from the air blower 1 on the surface (e.g., the upper surface 701 of the desk 700), presented by the light L8 emitted from the lighting fixture 8. This makes the airflow's reachable range visualized, thus allowing the person to visually recognize the airflow's reachable range. In addition, the airflow control system 100 according to the first embodiment allows the person to visually recognize the reachable range of the functional component supplied to the airflow by visualizing the airflow's reachable range.

In addition, in the airflow control system 100 according to the first embodiment, the controller 10 controls the supplier 7. Thus, in the airflow control system 100, making the controller 10 control the air blower 1, the supplier 7, and the lighting fixture 8 allows the controller 10 to control the timing to let the person visually recognize the reachable range of the functional component supplied to the airflow.

### (5.2) Control Method

The control method according to the first embodiment includes: controlling the air blower 1 to allow an airflow with directivity to blow out from the outlet port 24 of the air blower 1; and having light L8 with directivity emitted from the lighting fixture 8 in a direction aligned with the direction F3 in which the airflow is allowed to blow out from the air blower 1. This control method allows the person to visually recognize the reachable range of the airflow. More specifically, this control method may have a sign, related to the airflow's reachable range, presented to a person who is using the space covering the reachable range of the airflow that has blown out from the air blower 1. This makes the airflow's reachable range visualized, thus allowing the person to visually recognize the airflow's reachable range. In addition, the control method according to the first embodiment also allows the person to visually recognize the reachable range of the functional component supplied to the airflow by visualizing the airflow's reachable range.

### (5.3) Program

A program according to the first embodiment is a (computer) program designed to cause a computer system to perform the control method described above. This program, as well as the control method described above, also allows a person to visually recognize the airflow's reachable range.

### First Variation of First Embodiment

An airflow control system 100 according to a first variation of the first embodiment has the same basic configuration as the airflow control system 100 according to the first embodiment described above, and therefore, illustration and description thereof will be omitted herein. The airflow control system 100 according to the first variation of the first embodiment may have, as a plurality of control modes for the air blower 1, a first control mode and a second control mode different from the first control mode. The velocity of the airflow blowing out from the outlet port 24 of the air blower 1 when the controller 10 controls the air blower 1 in the second control mode is lower than the velocity of the airflow blowing out from the outlet port 24 of the air blower 1 when the controller 10 controls the air blower 1 in the first control mode. This makes the directivity of the airflow blowing out from the outlet port 24 of the air blower 1 when the controller 10 controls the air blower 1 in the second control mode lower than the directivity of the airflow blowing out from the outlet port 24 of the air blower 1 when the controller 10 controls the air blower 1 in the first control mode. Thus, the reachable range of the airflow blowing out from the outlet port 24 of the air blower 1 when the controller 10 controls the air blower 1 in the second control mode is broader than the reachable range of the airflow blowing out from the outlet port 24 of the air blower 1 when the controller 10 controls the air blower 1 in the first control mode.

The controller 10 controls the lighting fixture 8 to change the color temperature of the light emitted from the lighting fixture 8 depending on whether the controller 10 controls the air blower 1 in the first control mode or in the second control mode. This allows the airflow control system 100 according to the first variation of the first embodiment to change the color temperature of the light L8 emitted from the lighting fixture 8 according to the velocity of the airflow blowing out from the outlet port 24 of the air blower 1. For example, the controller 10 may make the lighting fixture 8 emit bluish white light when controlling the air blower 1 in the first control mode and may make the lighting fixture 8 emit reddish white light when controlling the air blower 1 in the second control mode.

Optionally, the controller 10 may change the control mode of the air blower 1 in accordance with an operating command entered through an operating unit (such as a remote controller or an operating switch) which may be operated by a person. In that case, the controller 10 may include, for example, a receiver which receives a wireless signal from the operating unit.

Alternatively, the controller 10 may also control the air blower 1 in either the first control mode or the second control mode according to the number of persons detected by a human detection sensor. In that case, the controller 10 may include, for example, a receiver which receives a wireless signal from the human detection sensor. Alternatively, the airflow control system 100 may include the human detection sensor. The human detection sensor detects the presence of a person in a detection area covering the space to which the airflow is supplied from the air blower 1. In a situation where the controller 10 controls the supplier 7 according to the number of persons detected by the human detection sensor, the controller 10 controls the supplier 7 in the first control mode if the number of persons detected is one and controls the supplier 7 in the second control mode if the number of persons detected is equal to or greater than two. This control method may make the range to which the functional component is to be carried narrower when the number of persons detected is one than when the number of persons detected is equal to or greater than two. In other words, this control method may make the range to which the functional component is to be carried broader when the number of persons detected is equal to or greater than two than when the number of persons detected is one.

### Second Variation of First Embodiment

An airflow control system 100 according to a second variation of the first embodiment has the same basic configuration as the airflow control system 100 according to the first embodiment described above, and therefore, illustration and description thereof will be omitted herein. In the airflow control system 100 according to the second variation of the first embodiment, as well as the airflow control system 100 according to the first variation described above, the controller 10 may also have, as a plurality of control modes for the air blower 1, a first control mode and a second control mode different from the first control mode. The velocity of the airflow blowing out from the outlet port 24 of the air blower 1 when the controller 10 controls the air blower 1 in the second control mode is lower than the velocity of the airflow blowing out from the outlet port 24 of the air blower 1 when the controller 10 controls the air blower 1 in the first control mode.

In the airflow control system 100 according to the second variation, the controller 10 may control the lighting fixture 8 to change a lighting pattern of the lighting fixture 8 depending on whether the controller 10 controls the air blower 1 in the first control mode or in the second control mode. This allows the airflow control system 100 according to the second variation to change the lighting pattern of the lighting fixture 8 according to the velocity of the airflow blowing out from the outlet port 24 of the air blower 1. Examples of the lighting patterns include continuous lighting and flashing.

In the supplier 7 of the airflow control system 100 according to the second variation, the generator 71 includes a plurality of atomizers for atomizing solutions containing mutually different functional components. In that case, the airflow control system 100 according to the second variation may have the generator 71 controlled by the controller 10 to change the functional component supplied to the airflow blowing out from the outlet port 24.

For example, in the first control mode, the airflow control system 100 may make the supplier 7 supply a disinfection component as the functional component to the airflow while controlling the lighting fixture 8 to emit flashing light. On the other hand, in the second control mode, the airflow control system 100 may make the supplier 7 supply a fragrance component as the functional component to the airflow while controlling the lighting fixture 8 to emit light continuously. Alternatively, if the lighting pattern needs be to be changed, the airflow control system 100 may make, in the first control mode, the supplier 7 supply a disinfection component as the functional component to the airflow while setting the intensity of the light emitted from the lighting fixture 8 at a dimming level of 100%. In the second control mode, on the other hand, the airflow control system 100 may make the supplier 7 supply a fragrance component intermittently to the airflow while setting the intensity of the light emitted from the lighting fixture 8 at a dimming level of 50%. As used herein, the “dimming level” may be expressed as the ratio [%] of average electric power supplied per unit time to the lighting fixture 8 to the normal rated power. For example, if the average electric power supplied per unit time to the lighting fixture 8 is a half of the normal rated power, then the dimming level is 50%.

### Second Embodiment

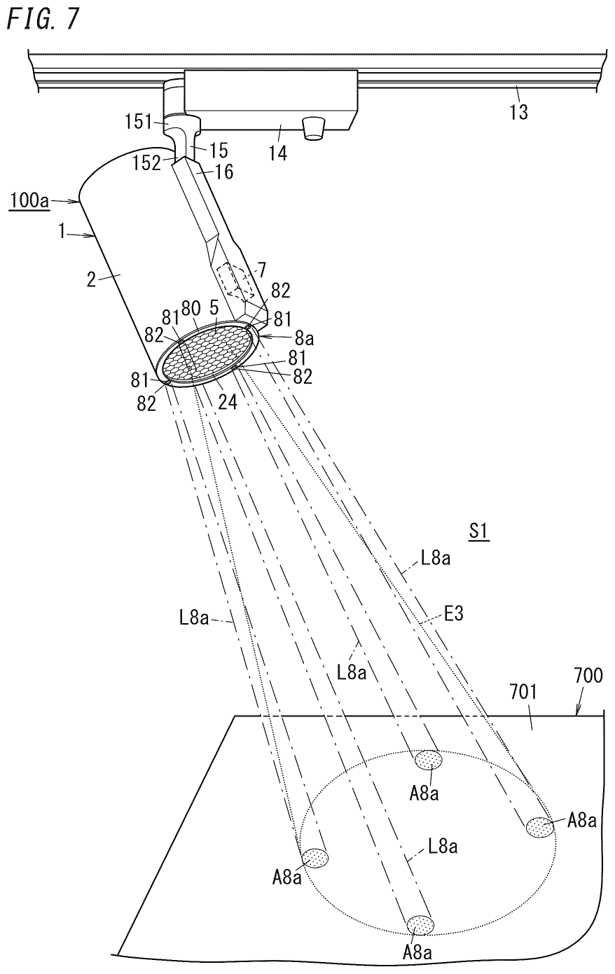

An airflow control system 100a and control method according to a second embodiment will now be described with reference to FIG. 7. The airflow control system 100a according to the second embodiment includes a lighting fixture 8a instead of the lighting fixture 8 of the airflow control system 100 according to the first embodiment, which is a difference from the airflow control system 100 according to the first embodiment. In the following description, any constituent element of the airflow control system 100a according to this second embodiment, having the same function as a counterpart of the airflow control system 100 according to the first embodiment described above, will be designated by the same reference numeral as that counterpart's, and description thereof will be omitted herein.

The lighting fixture 8a includes a mount board 80, a plurality of (e.g., four) light sources 81 mounted on the mount board 80, and a plurality of lenses 82 corresponding one to one to the plurality of light sources 81. The number of the light sources 81 provided for the lighting fixture 8a is smaller than the number of the light sources 81 provided for the lighting fixture 8a. When viewed in a direction aligned with the center axis of the outlet port 24 of the air blower 1 (i.e., in the axial direction D3 of the fan 3), the plurality of light sources 81 are arranged to be spaced from each other at regular intervals. As used herein, the phrase “arranged at regular intervals” refers to not only a situation where the light sources 81 are arranged at exactly the same intervals but also a situation where the difference between the intervals and a predefined interval falls within a predetermined tolerance range (e.g., within ±10% of the predefined interval). Each of the plurality of lenses 82 covers a corresponding one of the light sources 81. Each of the plurality of lenses 82 has a bullet shape and collimates the light coming from a corresponding one of the light sources 81. When viewed in a direction aligned with the center axis of the outlet port 24 of the air blower 1 (i.e., in the axial direction D3 of the fan 3), the plurality of lenses 82 are arranged to be spaced from each other at regular intervals.

The lighting fixture 8a may emit light rays L8a, each having directivity in a direction aligned with a direction F3 (refer to FIGS. 1 and 2) in which the airflow blows out from the outlet port 24 of the air blower 1. The light rays L8a emitted from the lighting fixture 8a are light rays emitted from the plurality of light sources 81 which have been collimated by the lenses 82. The lighting fixture 8a is arranged to surround the outlet port 24 of the cylindrical member 2 of the air blower 1 such that the respective optical axes of the plurality of light sources 81 and the lenses 82 are parallel to the center axis of the outlet port 24 of the air blower 1. In this embodiment, the respective optical axes of the plurality of light sources 81 and the lenses 82 are parallel to the center axis of the outlet port 24 of the air blower 1. However, the respective optical axes of the plurality of light sources 81 and the lenses 82 do not have to be exactly parallel to the center axis of the outlet port 24 of the air blower 1 but the angle formed between the respective optical axes of the plurality of light sources 81 and the lenses 82 and the center axis of the outlet port 24 of the air blower 1 may be equal to or less than 10 degrees.

The lighting fixture 8a, as well as the lighting fixture 8 of the airflow control system 100 according to the first embodiment, is controlled by the controller 10 (refer to FIG. 3).

The airflow control system 100a according to the second embodiment includes the lighting fixture 8a which may emit the light rays L8a, each having directivity in a direction aligned with the direction F3 in which the airflow blows out from the outlet port 24 of the air blower 1, thus allowing the person to visually recognize the reachable range of the airflow. The controller 10 may also make, while controlling the air blower 1 to let the airflow with directivity blow out from the outlet port 24 of the air blower 1, the lighting fixture 8a emit the light rays L8 with directivity either intermittently or continuously, whichever is appropriate. Alternatively, the controller 10 may also control, while controlling the air blower 1 to let the airflow with directivity blow out from the outlet port 24 of the air blower 1 and making the supplier 7 supply the functional component to the airflow, the lighting fixture 8a to emit the light rays L8a with directivity. This allows the airflow control system 100a to have a sign, related to the reachable range of the airflow and the functional component on the upper surface 701 of the desk 700 in the target space S1 at the facility, presented (indicated) by the light rays L8a emitted from the lighting fixture 8a. In the airflow control system 100a, the respective outer peripheries of a plurality of circular areas A8a irradiated, on the upper surface 701 of the desk 700, with the light rays L8a coming from the lighting fixture 8a partially overlap with the outer periphery of the range E3 that the airflow and the functional component have reached.

### Third Embodiment

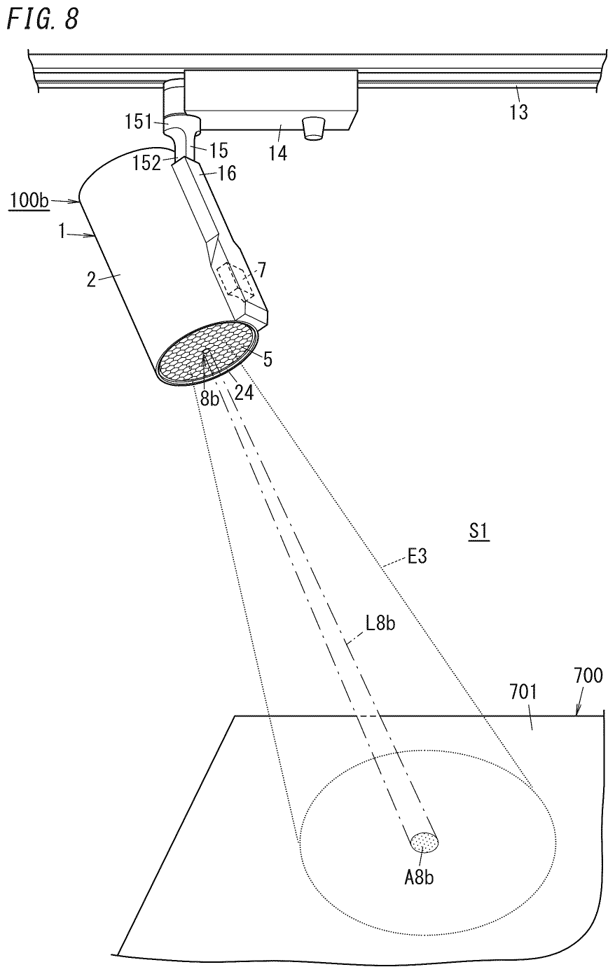

An airflow control system 100b according to a third embodiment will now be described with reference to FIGS. 8, 9, 10A, and 10B. The airflow control system 100b according to the third embodiment includes a lighting fixture 8b instead of the lighting fixture 8 of the airflow control system 100 according to the first embodiment, which is a difference from the airflow control system 100 according to the first embodiment. In the following description, any constituent element of the airflow control system 100b according to this third embodiment, having the same function as a counterpart of the airflow control system 100 according to the first embodiment described above, will be designated by the same reference numeral as that counterpart's, and description thereof will be omitted herein.

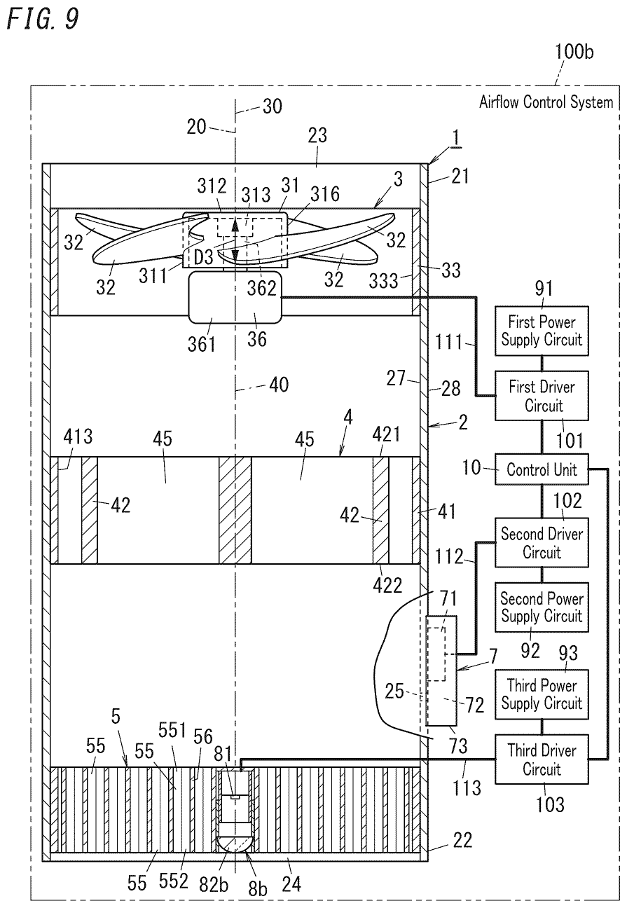

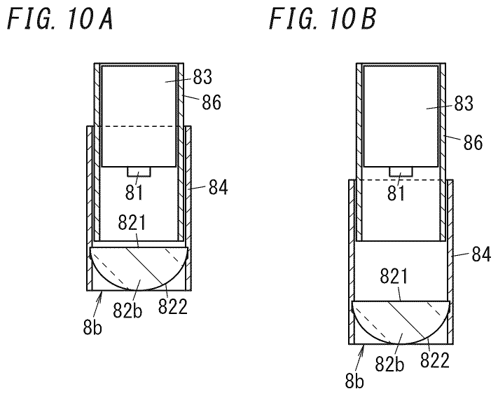

As shown in FIGS. 9, 10A, and 10B, the lighting fixture 8b includes a light source 81 and a lens 82b. The lens 82b is arranged to be spaced from the light source 81 in the direction aligned with the optical axis of the light source 81. The lighting fixture 8b is disposed inside the cylindrical member 2 to make the optical axis of the light source 81 aligned with the center axis 20 of the cylindrical member 2. The lighting fixture 8b is held by the second rectifier 5. The lighting fixture 8b is disposed at the center of the second rectifier 5 when viewed from the outlet port 24 of the cylindrical member 2. The lens 82b is a plano-convex lens, of which a first lens surface 821 facing the light source 81 is a flat surface and a second lens surface 822 opposite from the light source 81 is a curved convex surface. The lens 82b controls the light distribution of the light emitted from the light source 81. The lighting fixture 8b may change the light distribution of the light emitted from the lighting fixture 8b by changing the distance between the light source 81 and the lens 82b as shown in FIGS. 10A and 10B. The light emitted from the lighting fixture 8b is light emerging from the second lens surface 822 of the lens 82b.

The lighting fixture 8b includes a circular columnar holder 83 that holds the light source 81, a cylindrical supporting member 84 that houses and supports the lens 82b, and a slide mechanism. The slide mechanism may be disposed, for example, on the outer peripheral surface of the holder 83. The slide mechanism includes: a long guide rail 86 which is elongate in the direction aligned with the optical axis of the light source 81; and a sliding member disposed on the inner circumferential surface of the supporting member 84 to slide along the guide rail. The lighting fixture 8b may change the distance between the light source 81 and the lens 82b by sliding the sliding member along the guide rail 86.

The airflow control system 100b includes, separately from the third driver circuit 103 for driving the light source 81, an actuator for driving the slide mechanism. The actuator is controlled by the controller 10. In the airflow control system 100b, the actuator slides the sliding member of the slide mechanism to adjust the distance between the light source 81 and the lens 82b. The lighting fixture 8b may broaden the irradiation range of the light emitted from the lighting fixture 8b by making the distance between the light source 81 and the lens 82b shorter as shown in FIG. 10A than in FIG. 10B.

In the airflow control system 100b, the controller 10 controls the irradiation range (light distribution angle) of the light L8b emitted from the lighting fixture 8b according to the velocity of the airflow blowing out from the air blower 1. In the airflow control system 100b, the higher the velocity of the airflow blowing out from the outlet port 24 of the air blower 1 is, the narrower the reachable range of the airflow on the upper surface 701 of the desk 700 is. In other words, the lower the velocity of the airflow is, the broader the reachable range of the airflow on the upper surface 701 of the desk 700 is.

The controller 10 controls the lighting fixture 8b to change the distance between the light source 81 and the lens 82b in the lighting fixture 8b according to the velocity of the airflow blowing out from the air blower 1. More specifically, the controller 10 controls the lighting fixture 8b to change the distance between the light source 81 and the lens 82b in the lighting fixture 8b according to the drive voltage for the motor 36 of the fan 3 in the air blower 1. This allows the airflow control system 100b to change the irradiation range of the light L8b emitted from the lighting fixture 8b according to the reachable range of the airflow blowing out from the outlet port 24 of the air blower 1. Consequently, the airflow control system 100b may align the outer periphery of the circular area A8b irradiated with the light L8b on the upper surface 701 of the desk 700 with the outer periphery of the range E3 that the airflow and the functional component have reached.

The airflow control system 100b according to the third embodiment includes the lighting fixture 8b which may emit the light L8b having directivity in a direction aligned with the direction F3 (refer to FIGS. 1 and 2) in which the airflow blows out from the outlet port 24 of the air blower 1, thus allowing the person to visually recognize the reachable range of the airflow.

In addition, the airflow control system 100b according to the third embodiment allows an area covering at least the center of the airflow's reachable range to be irradiated, with more reliability, with the light L8b coming from the lighting fixture 8b. The controller 10 may also make, while controlling the air blower 1 to let the airflow with directivity blow out from the outlet port 24 of the air blower 1, the lighting fixture 8b emit the light L8b with directivity either intermittently or continuously, whichever is appropriate. Alternatively, the controller 10 may also control, while controlling the air blower 1 to let the airflow with directivity blow out from the outlet port 24 of the air blower 1 and making the supplier 7 supply the functional component to the airflow, the lighting fixture 8b to emit the light L8b with directivity. This allows the airflow control system 100 to have a sign, related to the reachable range of the airflow and the functional component on the upper surface 701 of the desk 700 in the target space S1 at the facility, presented (indicated) by the light L8b emitted from the lighting fixture 8b.

### Fourth Embodiment

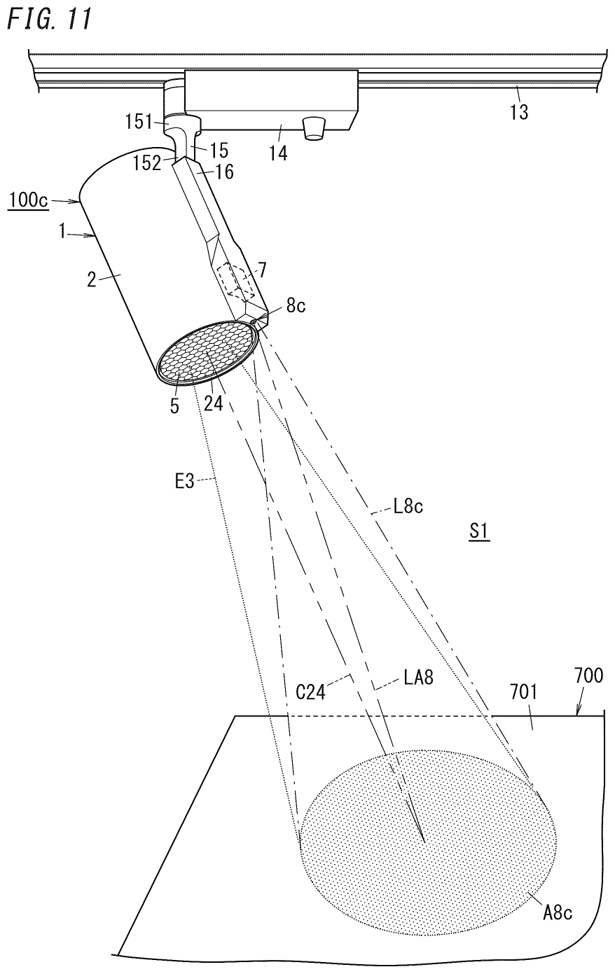

An airflow control system 100c according to a fourth embodiment will now be described with reference to FIG. 11. The airflow control system 100c according to the fourth embodiment includes a lighting fixture 8c instead of the lighting fixture 8 of the airflow control system 100 according to the first embodiment, which is a difference from the airflow control system 100 according to the first embodiment. In the following description, any constituent element of the airflow control system 100c according to this fourth embodiment, having the same function as a counterpart of the airflow control system 100 according to the first embodiment described above, will be designated by the same reference numeral as that counterpart's, and description thereof will be omitted herein.

The lighting fixture 8c is disposed outside the cylindrical member 2. More specifically, the lighting fixture 8c is arranged outside the cylindrical member 2 to avoid overlapping with the cylindrical member 2 in the axial direction of the cylindrical member 2.

The lighting fixture 8c is arranged to let the center axis C24 of the outlet port 24 of the air blower 1 and the optical axis LA8 of the lighting fixture 8c intersect with each other at a predetermined distance from the outlet port 24 of the air blower 1. The lighting fixture 8c may include, for example, a mount board, a single light source mounted on the mount board, and a lens covering the light source. The light source of the lighting fixture 8c, as well as the light sources 81 of the lighting fixture 8 in the airflow control system 100 according to the first embodiment, may be, for example, an LED. Nevertheless, the optical axis LA8 of the lighting fixture 8c is not parallel to the center axis C24 of the outlet port 24 of the cylindrical member 2. The optical axis LA8 of the lighting fixture 8c may be the same as, for example, the optical axis of the light source of the lighting fixture 8c.

The predetermined distance may be, for example, a distance, set on the center axis C24 of the outlet port 24 of the cylindrical member 2, between the outlet port 24 and a virtual plane (e.g., the upper surface 701 of the desk 700 as a target) that the airflow is supposed to reach. Thus, in the airflow control system 100c according to the fourth embodiment, the intersection between the center axis C24 of the outlet port 24 of the cylindrical member 2 and the optical axis LA8 of the lighting fixture 8c is located on the virtual plane.

The lighting fixture 8c, as well as the lighting fixture 8 of the airflow control system 100 according to the first embodiment, is controlled by the controller 10 (refer to FIG. 3).

The airflow control system 100c according to the fourth embodiment includes the lighting fixture 8c and the controller 10, thus allowing the person to visually recognize the airflow's reachable range. The controller 10 may also make, while controlling the air blower 1 to let the airflow with directivity blow out from the outlet port 24 of the air blower 1, the lighting fixture 8c emit the light L8c with directivity either intermittently or continuously, whichever is appropriate. Alternatively, the controller 10 may also control, while controlling the air blower 1 to let the airflow with directivity blow out from the outlet port 24 of the air blower 1 and making the supplier 7 supply the functional component to the airflow, the lighting fixture 8c to emit the light L8c with directivity. This allows the airflow control system 100c to have a sign, related to the reachable range of the airflow and the functional component on the upper surface 701 of the desk 700 in the target space S1 at the facility, presented (indicated) by the light L8c emitted from the lighting fixture 8c. Consequently, the airflow control system 100c may align the outer periphery of the circular area A8c irradiated with the light L8c on the upper surface 701 of the desk 700 with the outer periphery of the range E3 that the airflow and the functional component have reached.

### Variations

Note that the first to fourth embodiments described above are only exemplary ones of various embodiments of the present invention and should not be construed as limiting. Rather, the first to fourth embodiments may be readily modified in various manners depending on a design choice or any other factor without departing from the scope of the present disclosure. Optionally, mutually different constituent elements of multiple different ones of those embodiments may be adopted in combination as appropriate.

For example, the functional component supplied from the supplier 7 to the airflow may be, for example, charged water particles including OH radicals. In that case, the generator 71 may be, for example, an electrostatic atomizer for generating charged water particles including OH radicals. The charged water particles are fine particle ions of a nanometer scale. The electrostatic atomizer may generate fine particle ions having a particle size falling within the range from 5 nm to 20 nm by applying a high voltage to water in the air, for example. In the charged water particles, the OH radicals readily act on various substances.

Alternatively, the supplier 7 may include a fan that feeds the mist containing the functional component into the cylindrical member 2.

Also, the LEDs serving as the light sources 81 do not have to include the blue LED chip, the green LED chip, and the red LED chip. Alternatively, the light sources 81 may also include a blue LED chip and a wavelength converting portion containing a wavelength-converting element for converting the wavelength of a part of the blue ray emitted from the blue LED chip to radiate a light ray having a different wavelength from the blue ray. The wavelength-converting element may be phosphor particles. The wavelength-converting portion may include, for example, a light-transmitting material portion and phosphor particles. In this case, the wavelength-converting portion is formed as a mixture of the light-transmitting material portion and the phosphor particles. In the wavelength-converting portion, there are a great number of phosphor particles inside the light-transmitting material portion. A material for the light-transmitting material portion (i.e., light-transmitting material) is preferably a material that has high transmittance to visible light. The light-transmitting material may be, for example, a silicone-based resin. As the phosphor particles, yellow phosphor particles that radiate yellow light may be adopted, for example. The light (fluorescence) radiated from the yellow phosphor particles preferably has an emission spectrum having a primary emission peak wavelength in a wavelength range equal to or longer than 530 nm and equal to or shorter than 580 nm, for example. The yellow phosphor particles may be, but do not have to be, Y₃Al₅O₁₂ activated with Ce. In addition, the wavelength-converting portion does not have to include only the yellow phosphor particles as the wavelength-converting element but may include yellow phosphor particles, yellow-green phosphor particles, green phosphor particles, and red phosphor particles. That is to say, the wavelength-converting portion may include multiple types of phosphor particles.

Alternatively, the light sources 81 may each include, for example, a first blue LED chip, a second blue LED chip, a first wavelength-converting portion, and a second wavelength-converting portion. The first blue LED chip radiates a first blue ray. The second blue LED chip radiates a second blue ray. The first wavelength-converting portion includes green phosphor particles which are excited by the first blue ray to radiate a green ray. The second wavelength-converting portion includes red phosphor particles which are excited by the second blue ray to radiate a red ray. The peak wavelength of the second blue ray may be the same as, or different from, the peak wavelength of the first blue ray, whichever is appropriate.

Furthermore, the light sources 81 do not have to be LEDs but may also be, for example, organic electroluminescent (EL) elements or semiconductor laser diodes.

Alternatively, the controller 10 of the airflow control system 100 according to the first embodiment may also control the (fan 3 of the) air blower 1, the supplier 7, and the lighting fixture 8 in accordance with, for example, information acquired from a sensor. Examples of the sensors include an image sensor, a human detection sensor, an ultrasonic sensor, a Doppler sensor, a radio wave sensor, a biometric information sensor, a behavior sensor, and an environmental sensor. Any image sensor may be used as long as the image sensor may provide information about a target object (such as a person) present in the target space S1. Examples of the image sensor include an infrared image sensor, a complementary metal-oxide semiconductor (CMOS) image sensor, a charge-coupled device (CCD) image sensor, and a distance image sensor representing the distance as a pixel value. Examples of the biometric information sensors include a wearable terminal for measuring at least the heartbeat. Examples of such a wearable terminal for measuring at least the heartbeat include a wristband- or watch-type wearable terminal that a person who goes into, and comes out of, the target space S1 is supposed to wear on the wrist. The behavior sensor may be implemented as, for example, a location information acquisition system. The location information acquisition system is a system designed to acquire the location information of a transmitter that a target person carries with him or her by using the transmitter and a receiver installed at a facility. The location information acquisition system regards the location of the transmitter as the person's current location on the premise that he or she carries the transmitter with him or her. The transmitter has the capability of transmitting a wireless signal. The transmitter transmits the wireless signals in predetermined cycles. The wireless signal may include the identification information of the transmitter. The identification information may be used to distinguish a plurality of transmitters from each other. In the transmitter, the identification information may be stored in, for example, the transmitter's own storage unit. The storage unit may be, for example, a nonvolatile memory such as an electrically erasable programmable read-only memory (EEPROM). The behavior sensor may use, for example, a location information acquisition system that uses a beacon. However, this is only an example and should not be construed as limiting. Alternatively, the behavior sensor may also be a sensor which uses the global positioning system (GPS), for example. Examples of the environmental sensors include an odor sensor, a temperature sensor, a humidity sensor, and a CO₂ sensor.

Optionally, the controller 10 may control at least one of the air blower 1, the supplier 7, or the lighting fixture 8 in accordance with, for example, the output of an artificial intelligence (AI) speaker which accepts human speech input. Alternatively, the controller 10 may also control at least one of the air blower 1, the supplier 7, or the lighting fixture 8 in accordance with the speech such as conversation between persons present in the target area. Optionally, the controller 10 may change the control mode of at least one of the air blower 1, the supplier 7, or the lighting fixture 8 in accordance with, for example, the output of an AI speaker which accepts human speech input.

Also, in the plurality of fins 42 of the first rectifier 4, not all of their first ends 421 and all of their second ends 422 have to overlap with each other, but at least some of their first ends 421 and at least some of their second ends 422 may overlap with each other, when viewed in the axial direction D3 of the fan 3. Alternatively, each of the plurality of fins 42 may also be configured such that the first end 421 and the second end 422 thereof do not overlap with each other when viewed in the axial direction D3.

Also, in the second rectifier 5, the rectifying grid 50 does not have to have the honeycomb grid shape but may also have, for example, the shape of a square grid or a triangular grid.

Furthermore, the second rectifier 5 does not have to be the rectifying grid 50 but may also be a rectifying grid including a bundle of a plurality of (e.g., 19) fine tubes or may also be a porous plate (e.g., a punched metal sheet). Each of the plurality of fine tubes includes the flow channel 55. The porous plate has a plurality of through holes serving as the plurality of flow channels 55.

Optionally, the air blower 1 may further include a third rectifier interposed, in the axial direction D3 of the fan 3, between the first rectifier 4 and the second rectifier 5. The third rectifier includes an inner cylindrical member, which is disposed inside the cylindrical member 2 to be coaxial with the cylindrical member 2, and a plurality of attachments for attaching the inner cylindrical member to the cylindrical member 2. The inside diameter and outside diameter of the inner cylindrical member decrease in the axial direction D3 of the fan 3 toward the outlet port 24. The third rectifier functions as a diaphragm which rectifies the airflow to further increase the velocity of the airflow in the first region, and to further decrease the velocity of the airflow in the second region, downstream of the first rectifier 4. The inner cylindrical member may have the shape of a circular cylinder, of which the inside and outside diameters are constant in the axial direction D3 of the fan 3. Alternatively, the inner cylindrical member may include a diameter narrowing (i.e., tapering) portion, of which the inside and outside diameters change gradually, and a circular cylindrical portion, of which the inside and outside diameters are constant. The air blower 1 including the third rectifier may increase the flow velocity in the inner region of the outlet port 24 and decrease the flow velocity in the outer region of the outlet port 24, thus widening the difference in flow velocity between the inner and outer regions of the outlet port 24 and increasing the degree of directivity of the airflow blowing out from the outlet port 24, compared to the air blower 1 including no third rectifier.

Optionally, in the air blower 1, the cylindrical member 2 may also serve as the fan housing 33 of the fan 3. Furthermore, in the air blower 1, the cylindrical member 2 may also serve as the cylindrical portion 41 of the first rectifier 4. Furthermore, in the air blower 1, the cylindrical member 2 may also serve as the cylindrical portion 51 of the second rectifier 5.

The cylindrical member 2 has only to have the inlet port 23 at the first end 21 thereof and the outlet port 24 at the second end 22 thereof and does not have to have the circular cylindrical shape.

Alternatively, the air blower 1 may be embedded in a ceiling material such that the outlet port 24 of the cylindrical member 2 faces the target space S1. Still alternatively, the cylindrical member 2 may also be mounted on either a wall or a pedestal.

Furthermore, the air blower 1 may also be configured to allow the air coming from an air conditioner unit provided upstream of the air blower 1 to flow into the air blower 1 through the inlet port 23 of the cylindrical member 2. The air conditioner unit may be, but does not have to be, a blower. Alternatively, the air conditioner unit may also be, for example, a ventilator, an air conditioner, an air supplying cabinet fan, or an air conditioning system including a blower and a heat exchanger.

### Aspects

The foregoing description provides specific implementations of the following aspects of the present disclosure.

An airflow control system (100; 100a; 100b) according to a first aspect includes an air blower (1), a supplier (7), a lighting fixture (8; 8a; 8b), and a controller (10). The air blower (1) has an outlet port (24), from which an airflow with directivity is allowed to blow out. The supplier (7) may supply the airflow blowing out from the outlet port (24) with a functional component to be eventually emitted into the air. The lighting fixture (8; 8a; 8b) may emit light (L8; L8a; L8b) having directivity in a direction aligned with a direction (F3) in which the airflow blows out from the outlet port (24) of the air blower (1). The controller (10) controls the air blower (1) and the lighting fixture (8; 8a; 8b).

The airflow control system (100; 100a; 100b) according to the first aspect allows a person to visually recognize the reachable range of the airflow.

In an airflow control system (100; 100a; 100b) according to a second aspect, which may be implemented in conjunction with the first aspect, the controller (10) controls the supplier (7).

In the airflow control system (100; 100a; 100b) according to the second aspect, the controller (10) controls the air blower (1), the supplier (7), and the lighting fixture (8; 8a; 8b), thus allowing the controller (10) to control the timing to let the person visually recognize the reachable range of the functional component supplied to the airflow.

In an airflow control system (100; 100a) according to a third aspect, which may be implemented in conjunction with the first or second aspect, the air blower (1) includes a cylindrical member (2) having a first end (21) and second end (22). The cylindrical member (2) has an inlet port (23) for a gas at the first end (21) and the outlet port (24) at the second end (22). The lighting fixture (8; 8a) is arranged to surround the outlet port (24) of the cylindrical member (2).

The airflow control system (100; 100a) according to the third aspect may prevent the airflow blowing out from the outlet port (24) of the air blower (1) from being disturbed by the lighting fixture (8; 8a).

In an airflow control system (100b) according to a fourth aspect, which may be implemented in conjunction with the first or second aspect, the air blower (1) includes a cylindrical member (2) having a first end (21) and a second end (22). The cylindrical member (2) has an inlet port (23) for a gas at the first end (21) and the outlet port (24) at the second end (22). The lighting fixture (8b) is disposed inside the cylindrical member (2).

The airflow control system (100b) according to the fourth aspect allows the airflow's reachable range to be irradiated, with more reliability, with the light (L8b) coming from the lighting fixture (8b).

In an airflow control system (100b) according to a fifth aspect, which may be implemented in conjunction with any one of the first to fourth aspects, the controller (10) controls, according to a velocity of the airflow allowed to blow out from the outlet port (24) of the air blower (1), an irradiation range of the light (L8b) emitted from the lighting fixture (8b).

The airflow control system (100b) according to the fifth aspect allows the irradiation range of the light (L8b) emitted from the lighting fixture (8b) to be changed according to the reachable range of the airflow blowing out from the outlet port (24) of the air blower (1).

In an airflow control system (100; 100a; 100b) according to a sixth aspect, which may be implemented in conjunction with any one of the first to fourth aspects, the controller (10) controls the air blower (1) in a plurality of control modes including: a first control mode; and a second control mode different from the first control mode. A velocity of the airflow blowing out from the outlet port (24) of the air blower (1) when the controller (10) controls the air blower (1) in the second control mode is lower than a velocity of the airflow blowing out from the outlet port (24) of the air blower (1) when the controller (10) controls the air blower (1) in the first control mode. The controller (10) controls the lighting fixture (8; 8a; 8b) to change, depending on whether the controller (10) controls the air blower (1) in the first control mode or in the second control mode, a color temperature of the light emitted from the lighting fixture (8; 8a; 8b).

The airflow control system (100; 100a; 100b) according to the sixth aspect allows the color temperature of the light emitted from the lighting fixture (8; 8a; 8b) to be changed according to the velocity of the airflow blowing out from the outlet port (24) of the air blower (1).

In an airflow control system (100; 100a; 100b) according to a seventh aspect, which may be implemented in conjunction with any one of the first to fourth aspects, the controller (10) controls the air blower (1) in a plurality of control modes including: a first control mode; and a second control mode different from the first control mode. A velocity of the airflow blowing out from the outlet port (24) of the air blower (1) when the controller (10) controls the air blower (1) in the second control mode is lower than a velocity of the airflow blowing out from the outlet port (24) of the air blower (1) when the controller (10) controls the air blower (1) in the first control mode. The controller (10) controls the lighting fixture (8; 8a; 8b) to change a lighting pattern of the lighting fixture (8; 8a; 8b) depending on whether the controller (10) controls the air blower (1) in the first control mode or in the second control mode.

The airflow control system (100; 100a; 100b) according to the seventh aspect allows the lighting pattern of the lighting fixture (8; 8a; 8b) to be changed according to the velocity of the airflow blowing out from the outlet port (24) of the air blower (1).

An airflow control system (100c) according to an eighth aspect includes an air blower (1), a supplier (7), a lighting fixture (8c), and a controller (10). The air blower (1) has an outlet port (24), from which an airflow with directivity is allowed to blow out. The supplier (7) may supply the airflow blowing out from the outlet port (24) with a functional component to be eventually emitted into the air. The lighting fixture (8c) may emit light with directivity. The controller (10) controls the air blower (1) and the lighting fixture (8c). The air blower (1) includes a cylindrical member (2) having a first end (21) and a second end (22). The cylindrical member (2) has an inlet port (23) for a gas at the first end (21) and the outlet port (24) at the second end (22). The lighting fixture (8c) is disposed outside the cylindrical member (2). The lighting fixture (8c) is arranged such that at a predetermined distance from the outlet port (24) of the air blower (1), a center axis (C24) of the outlet port (24) of the air blower (1) intersects with an optical axis (LA8) of the lighting fixture (8c).

The airflow control system (100c) according to the eighth aspect allows a person to visually recognize the airflow's reachable range.

A control method according to a ninth aspect includes: controlling an air blower (1) to allow an airflow with directivity to blow out from an outlet port (24) of the air blower (1); and having light (L8; L8a; L8b) with directivity emitted from a lighting fixture (8; 8a; 8b) in a direction aligned with a direction (F3) in which the airflow is allowed to blow out from the air blower (1).

The control method according to the ninth aspect allows a person to visually recognize the airflow's reachable range.

A program according to a tenth aspect is designed to cause a computer system to perform the control method according to the ninth aspect.

The program according to the tenth aspect allows a person to visually recognize the airflow's reachable range.

### REFERENCE SIGNS LIST

1 Air Blower
2 Cylindrical Member
21 First End
22 Second End
23 Inlet Port
24 Outlet Port
7 Supplier
8, 8a, 8b, 8c Lighting Fixture
10 Controller
100, 100a, 100b, 100c Airflow Control System
C24 Center Axis
F3 Airflow Blowing Direction
L8, L8a, L8b, L8c Light
LA8 Optical Axis

1. An airflow control system comprising:
an air blower having an outlet port, from which an airflow with directivity is allowed to blow out;
a supplier configured to supply the airflow blowing out from the outlet port with a functional component to be eventually emitted into the air;
a lighting fixture configured to emit light having directivity in a direction aligned with a direction in which the airflow blows out from the outlet port of the air blower; and
a controller configured to control the air blower and the lighting fixture.

2. The airflow control system of claim 1, wherein
the controller is configured to control the supplier.

3. The airflow control system of claim 1, wherein
the air blower includes a cylindrical member having a first end and a second end, the cylindrical member having an inlet port for a gas at the first end and the outlet port at the second end, and
the lighting fixture is arranged to surround the outlet port of the cylindrical member.

4. The airflow control system of claim 1, wherein
the air blower includes a cylindrical member having a first end and a second end, the cylindrical member having an inlet port for a gas at the first end and the outlet port at the second end, and
the lighting fixture is disposed inside the cylindrical member.

5. The airflow control system of claim 1, wherein
the controller is configured to control, according to a velocity of the airflow allowed to blow out from the outlet port of the air blower, an irradiation range of the light emitted from the lighting fixture.

6. The airflow control system of claim 1, wherein
the controller is configured to control the air blower in a plurality of control modes including:
a first control mode; and
a second control mode different from the first control mode,
a velocity of the airflow blowing out from the outlet port of the air blower when the controller controls the air blower in the second control mode is lower than a velocity of the airflow blowing out from the outlet port of the air blower when the controller controls the air blower in the first control mode, and
the controller is configured to control the lighting fixture to change, depending on whether the controller controls the air blower in the first control mode or in the second control mode, a color temperature of the light emitted from the lighting fixture.

7. The airflow control system of claim 1, wherein
the controller is configured to control the air blower in a plurality of control modes including:
a first control mode; and
a second control mode different from the first control mode,
a velocity of the airflow blowing out from the outlet port of the air blower when the controller controls the air blower in the second control mode is lower than a velocity of the airflow blowing out from the outlet port of the air blower when the controller controls the air blower in the first control mode, and
the controller is configured to control the lighting fixture to change a lighting pattern of the lighting fixture depending on whether the controller controls the air blower in the first control mode or in the second control mode.

8. An airflow control system comprising:
an air blower having an outlet port, from which an airflow with directivity is allowed to blow out;
a supplier configured to supply the airflow blowing out from the outlet port with a functional component to be eventually emitted into the air;
a lighting fixture configured to emit light with directivity; and
a controller configured to control the air blower and the lighting fixture,
the air blower including a cylindrical member having a first end and a second end, the cylindrical member having an inlet port for a gas at the first end and the outlet port at the second end,
the lighting fixture being disposed outside the cylindrical member, and
the lighting fixture being arranged such that at a predetermined distance from the outlet port of the air blower, a center axis of the outlet port of the air blower intersects with an optical axis of the lighting fixture.

9. A control method comprising:
controlling an air blower to allow an airflow with directivity to blow out from an outlet port of the air blower; and
having light with directivity emitted from a lighting fixture in a direction aligned with a direction in which the airflow is allowed to blow out from the air blower.

10. A non-transitory storage medium storing a program designed to cause a computer system to perform the control method of claim 9.

11. The airflow control system of claim 2, wherein
the air blower includes a cylindrical member having a first end and a second end, the cylindrical member having an inlet port for a gas at the first end and the outlet port at the second end, and
the lighting fixture is arranged to surround the outlet port of the cylindrical member.

12. The airflow control system of claim 2, wherein
the air blower includes a cylindrical member having a first end and a second end, the cylindrical member having an inlet port for a gas at the first end and the outlet port at the second end, and
the lighting fixture is disposed inside the cylindrical member.

13. The airflow control system of claim 2, wherein
the controller is configured to control, according to a velocity of the airflow allowed to blow out from the outlet port of the air blower, an irradiation range of the light emitted from the lighting fixture.

14. The airflow control system of claim 3, wherein
the controller is configured to control, according to a velocity of the airflow allowed to blow out from the outlet port of the air blower, an irradiation range of the light emitted from the lighting fixture.

15. The airflow control system of claim 4, wherein
the controller is configured to control, according to a velocity of the airflow allowed to blow out from the outlet port of the air blower, an irradiation range of the light emitted from the lighting fixture.

16. The airflow control system of claim 2, wherein
the controller is configured to control the air blower in a plurality of control modes including:
a first control mode; and
a second control mode different from the first control mode,
a velocity of the airflow blowing out from the outlet port of the air blower when the controller controls the air blower in the second control mode is lower than a velocity of the airflow blowing out from the outlet port of the air blower when the controller controls the air blower in the first control mode, and
the controller is configured to control the lighting fixture to change, depending on whether the controller controls the air blower in the first control mode or in the second control mode, a color temperature of the light emitted from the lighting fixture.

17. The airflow control system of claim 3, wherein
the controller is configured to control the air blower in a plurality of control modes including:
a first control mode; and
a second control mode different from the first control mode,
a velocity of the airflow blowing out from the outlet port of the air blower when the controller controls the air blower in the second control mode is lower than a velocity of the airflow blowing out from the outlet port of the air blower when the controller controls the air blower in the first control mode, and
the controller is configured to control the lighting fixture to change, depending on whether the controller controls the air blower in the first control mode or in the second control mode, a color temperature of the light emitted from the lighting fixture.

18. The airflow control system of claim 4, wherein
the controller is configured to control the air blower in a plurality of control modes including:
a first control mode; and
a second control mode different from the first control mode,
a velocity of the airflow blowing out from the outlet port of the air blower when the controller controls the air blower in the second control mode is lower than a velocity of the airflow blowing out from the outlet port of the air blower when the controller controls the air blower in the first control mode, and
the controller is configured to control the lighting fixture to change, depending on whether the controller controls the air blower in the first control mode or in the second control mode, a color temperature of the light emitted from the lighting fixture.
